(19) United States
(12) Patent Application Publication
(10) Pub. No.: US 2003/0067538 A1
(43) Pub. Date: Apr. 10, 2003

(54) System and method for three-dimensional data acquisition

(76) Inventor: Kenneth J. Myers, Dobbs Ferry, NY (US)

Correspondence Address: BACON & THOMAS, PLLC, 625 SLATERS LANE, FOURTH FLOOR, ALEXANDRIA, VA, 22314

(21) Appl. No.: 10/050,538

(22) Filed: Jan. 18, 2002

Related U.S. Application Data
(63) Continuation-in-part of application No. 09/987,336, filed on Nov. 14, 2001.
Application No. 09/987,336 is a continuation-in-part of application No. 09/969,583, filed on Oct. 4, 2001.

(51) Int. Cl. H04N 13/02

(52) U.S. Cl. 348/47; 348/42; 348/139

(57) ABSTRACT

A system and method for capturing contours of a three-dimensional subject, and/or acquiring data correlated with three-dimensional geometric features or location of the subject, involves capture of a pattern or signature emitted or reflected by the subject under natural illumination, illumination by one or more projected grids, and/or patternless projected illumination, and in which the grids, patterns, or signatures are optically separated from a composite image of the subject using one or more receivers, each including one or more beam splitters, for direct viewing or further processing.

This application is a continuation-in-part of copending U.S. patent application Ser. No. 09/987,336, filed Nov. 14, 2001, which is a continuation-in-part of copending U.S. patent application Ser. No. 09/969,583, filed Oct. 4, 2001. Copending U.S. patent application Ser. Nos. 09/987,336 and 09/969,583 are hereby incorporated by reference.

### BACKGROUND OF THE INVENTION

1. Field of the Invention

This invention relates to a system and method for capturing images and related data in a format that facilitates interpretation of the images and data by a human viewer or processing by a computer or other electronic processing device.

U.S. patent application Ser. Nos. 09/987,336 and 09/969,583 disclose a system and method of stereoscopic data acquisition involving projection of one or more optical grids or other patterns onto a subject, the projected grid(s) or pattern(s) reflecting contours of the subject, and separation of the reflected grids or patterns for viewing or processing through the use of beam splitters. The present invention adds the possibility of using the system and method disclosed in the above-cited copending applications to collect stereoscopic data by illuminating the subject without projecting any sort of pattern onto the subject, and by utilizing background illumination and/or light, such as thermally induced infrared light, emitted by the subject itself.

This extension of the basic principles described in the copending applications will be useful in any situation in which the subject either (i) radiates a unique pattern at specific frequencies of light and therefore can be detected and the subject identified by separation of the frequencies radiated by the subject from background frequencies of light, or (ii) reflects projected light to form an identifiable pattern or signature that can be detected upon separation of the projected light frequencies from the background. In either case, three-dimensional or stereoscopic data acquisition can be carried out either by using spaced receivers to capture the identifiable pattern or signature from two or more different angles, or by illuminating the subject from multiple angles. For example, aircraft and incoming missiles have identifiable infrared light signatures that can be detected using infrared and visible light detectors, and matched filtering techniques. As in the copending applications, the contribution of the present invention is to use multiple detectors to detect the infrared light signatures from multiple angles, and to use optical processing to optically separate the signatures from background in order to facilitate subsequent processing. Reference grids, marks, or patterns may be included in the detectors, depending on the application, but such grids are not essential to this aspect of the invention.

Key features of the invention include:

a subject that emits or reflects a specific radiation pattern or signature at known frequencies (the phrase “a subject” referring to one or more subjects, without any other limitation as to the nature of the subject);

one or more frequency discriminators, each including one or more beam splitters, that optically separate out the received image of the emitted or reflected pattern or signature; and

for reflected radiation patterns or signatures, one or more radiation sources that emit radiation at frequencies corresponding to the patterns or signatures sought to be detected, either simultaneously or serially.

These key features of the invention may be used in connection with any of the applications disclosed in the copending applications, and in additional applications involving the use of fiber optics to direct images at appropriate receivers, thermography, or the use of frequency discrimination in combination with pass-through of the image (such as a night vision goggle that passes the combined image through to one eye, and a frequency discriminated image through to the other eye, and/or that is capable of switching between day and night vision) Also, the additional applications, including the use of fiber optics and combination with pass-through receivers may be used in connection with the grid projection arrangement disclosed in the copending applications.

2. Description of Related Art

The ability to rapidly capture or render images of a subject in a manner which enables movements of the subject to be tracked in three-dimensions, and/or to draw the subject as it moves, has been a goal of computer programmers for many years. One of the initial applications for such three-dimensional image capture and processing was to detect defects in the surfaces of manufactured items. More recently, proposals have been made to use three-dimensional image input systems and methods to control computers based on hand or eye movements, to insert images of persons into video games, to track movements of the subject to analyze the movements or so that the subject can interact with the video game or other virtual reality program, identify fingerprints or recognize persons based on their profiles, and/or for use in domestic security, air traffic control, or defense-related tracking, targeting, intelligence gathering, and guidance systems.

All of these applications require substantial processor resources, and even the simplest such systems tend to stretch the limits of currently available computer systems. The technology for utilizing three-dimensional data input is developing rapidly, but commercialization of the technology has been limited by either (i) the cost and complexity of current data input hardware and control software, or (ii) if simpler input means are used, the cost and complexity of image processing software necessary to make sense of the data. The present invention seeks to simplify both image capture hardware and the image processing software necessary to enable a projected grid to be captured, displayed, and/or analyzed.

To accomplish this, the present invention enables input either of a reference grid that captures the contours of the subject, a pattern or signature emitted by the subject, or a reflected pattern or signature having specific frequencies that can be separated from a composite image of the subject, by using simple optical means such as beam splitters to capture an electronic image of the grid that can be processed without the need to electronically separate it from its background. The contours, patterns, or signature represented by the optically separated grid can then be displayed without further electronic processing, or analyzed using relatively simple numerical analysis rather than more difficult qualitative analysis. While systems and methods that utilize grid projection and frequency discrimination are known, most rely on electronic processing techniques, and none simplifies processing as much as the present invention.

The following references illustrate general principles of three-dimensional imaging, measurement or mapping of three-dimensional surfaces using scanners, tracking of moving objects in three-dimensions, and/or stereoscopic image processing and analysis, but fail to show either the grid projection or image separation aspects of the present invention:

With respect to the grid projection aspect of the invention, U.S. Pat. No. 6,252,623 discloses imposing a three-color grid pattern on a subject, but the grid is created by projecting visible light through a color grating, which makes it difficult to distinguish the grid in the presence of background visible light, and separating the colors of the one-dimensional grid electronically rather than optically based on pixels activated by the CCD.

U.S. Pat. No. 6,205,243 discloses a system that projects laser scan lines onto a subject with sufficient rapidity to form a “mesh” in the composite image that can be used to determine surface contours. However, the use of laser scanning in the system of this patent makes the system much more complicated than is the case with a system that uses multiple light frequencies to distinguish an image of a subject from one or more reference grids projected onto the subject.

U.S. Pat. No. 5,982,352 discloses use of grid distortion to indicate the location and force of contact between a user and a surface, such as a touch screen surface or the floor. In several examples, the grid is projected onto the surface and captured by a “tv camera” connected to a computer, but there is no provision for use of multiple light frequencies to distinguish an image of the subject from the reference grid, or for optical separation so the grid from a composite image of the subject and grid.

Finally, with respect to the grid projection aspect of the invention, U.S. Pat. No. 6,191,850 discloses projection of a grid pattern onto an object of manufacture for the purpose of detecting surface defects, but there is again no provision for use of multiple light frequencies to distinguish an image of the subject from the reference grid, or for optical separation so the grid from a composite image of the subject and grid.

With respect to the optical separation or beam splitter aspect of the invention, U.S. Pat. No. 5,910,816 discloses the use of dichroic beam splitters to separate visible and infrared components of an image, but there is no way to separate infrared components from each other, and the infrared components do not represent a grid or other pattern projected onto the subject.

By way of background, numerous references disclose generation of a three-dimensional representation of a subject by utilizing scanning and/or complex image processing that does not rely on reference grids. For example, FIG. 3 of U.S. Pat. No. 5,531,520 shows “striping” created by processing data generated by a laser scanner. The striping is overlaid over an image of a or tumor for the purpose of assisting a surgeon in locating the tumor.

Similar laser scanning systems, for analyzing objects in a manufacturing setting, are disclosed in U.S. Pat. Nos. 4,628,469 and 4,498,778.

U.S. Pat. No. 5,129,010 discloses use of “infrared laser slit light” for the purpose of determining the flushness of an automobile assembly, but the “slit light” is scanned and does not form a grid, while U.S. Pat. Nos. 5,280,542 and 4,600,012 disclose similar systems utilizing non-infrared pulsed slit lines.

U.S. Pat. No. 4,914,460 discloses projection of a laser grid in the form of linear series of discrete spots onto an object, but only for the purpose of determining position and orientation of a submarine object.

U.S. Pat. Nos. 6,009,210 and 6,215,471 disclose a purely electronic computer input device which tracks a face by comparing an image of the face with reference images representing different positions, while U.S. Pat. No. 6,215,471 tracks a face by tracking movement of “landmarks” on the face, and U.S. Pat. No. 5,767,842 discloses a similar system for fingers.

The concept of using three-dimensional object sensing as a computer input means is also disclosed in U.S. Pat. No. 5,900,863, but the object sensing is either based on parallax range finding, or on determining object parameters by determining which of an array of light beams is reflected (or blocked) by the object. A more sophisticated and complex version of a computer input that employs object detection by pixel-analysis input device is disclosed in U.S. Pat. No. 6,144,366.

U.S. Pat. Nos. 6,002,808 and 6,222,465 disclose a respective “hand gesture control” and “video gesture recognition” system in which images of a hand are electronically analyzed to detect movement.

U.S. Pat. No. 5,235,416 discloses use of two cameras sensitive to different wavelengths, and two corresponding illumination sources to simultaneously image two sides of an object without interference, but does not disclose use of beam splitters to discriminate the image, or use of the cameras for stereoscopic imaging.

U.S. Pat. No. 5,528,263 discloses a system in which a grid is projected onto a two-dimensional projection screen to enable location of a pointer, rather than being projected onto a three-dimensional surface to indicate contours of the surface.

Finally, U.S. Pat. No. 4,499,492 is representative of a number of patents disclosing “range imaging employing parallax” which utilizes scanning to determine the distance to a selected point on an object. U.S. Pat. No. 6,198,485 discloses using such a range finding system to track a marker placed on a finger.

Similar “ladar” systems that use laser radar to acquire data on three-dimensional subjects for mapping, target acquisition, and similar applications, both civilian and military, are also disclosed in a paper entitled “Ladar systems for 3D measuring applications,” available on the Internet at “laseroptronic.com.” This paper describes a number of applications for 3D laser radar scanner units capable of measuring and storing up to 50,000 3D points/sec., but with no suggestion that projected optical grids and/or optical image processing can be used in connection with the radar scanner units to greatly increase data acquisition speeds or efficiency.

### SUMMARY OF THE INVENTION

It is accordingly a first objective of the invention to provide a simple and inexpensive system and method for capturing stereoscopic images and related data in a format that facilitates interpretation of the images and data by a human viewer or processing by a computer or other electronic processing device

It is a second objective of the invention to provide a system and method for capturing stereoscopic images and related data in a format that facilitates processing by a computer or other electronic processing device in a way that eliminates the need for feature extraction, interpolation, and other complex image processing software or algorithms.

It is a third objective of the invention to provide a system and method for capturing stereoscopic images and related data in a format that facilitates interpretation of the images and data by a human viewer or processing by a computer or other electronic processing device, and which does not require complex scanning hardware or software but rather may use ordinary fixed cameras or other viewing or image capture devices, and conventional light sources.

It is a fourth objective of the invention to provide a system and method for capturing contours of a three-dimensional subject that permits the contours to be captured and displayed without any further electronic processing.

It is a fifth objective of the invention to provide a system and method for capturing contours of a three-dimensional subject that enables correlation of superposed grid lines and a visible light image of the subject, while permitting direct analysis of the grid lines without the need for electronically separating the grid lines from the visible light image of the subject.

It is a sixth objective of the invention to provide a system and method for acquiring data concerning three-dimensional objects that provides range-related data as well as profile data.

It is a seventh objective of the invention to provide a system and method for acquiring data concerning three-dimensional objects that enables sampling or gating of as few as one pixel in a scanned image without loss of resolution.

It is a eighth objective of the invention to provide a ladar mapping, tracking, guidance, or target acquisition system having increased speed and accuracy without substantially increased complexity.

It is an ninth objective of the invention to provide a three-dimensional imaging system useful for guidance, tracking, target acquisition, and other similar applications, and that has reduced vulnerability to bloom, blinding, and deflection techniques.

It is a tenth objective of the invention to provide a three-dimensional imaging system that can track specific temperatures and shapes in a wide variety of environments, including at night and underwater, and that can relatively easily be configured to accomplish detailed analysis of subjects on scales ranging from microscopic to planetary.

These objectives are accomplished, in accordance with the principles of a preferred embodiment of the invention, by providing a system and method for capturing contours of a three-dimensional subject, and/or acquiring data correlated with three-dimensional geometric features or location of the subject, in which a two-dimensional grid is projected onto the three-dimensional subject, and/or in which a pattern or signature emitted or reflected by the subject is captured under natural illumination or patternless projected illumination, and in which the grid, pattern, or signature is optically separated from a composite image of the subject using one or more receivers, each including one or more beam splitters, for viewing or further processing.

The objectives of the invention are also accomplished by providing a system and method for capturing contours of a three-dimensional subject or related data, which uses optical separation of a grid, pattern, or radiation signature from the composite image so as to simplify electronic processing, and which in the case where multiple grids are used to achieve a stereoscopic effect without the need for multiple cameras situated at different angles, uses optical separation of the multiple grids from each other so as to further simplify subsequent electronic processing.

The objectives of the invention are further accomplished by providing a system and method for capturing contours of a three-dimensional subject, or related data, which uses a beam splitter to extract the grids from the visible light portion of the composite image of the subject, and a beam splitter to distinguish the grids from each other. Alternatively, separate images of the grids may be obtained through the use of discrete image capture devices or media sensitive to wavelengths or frequencies corresponding to those of one grid but not the other grid.

Those skilled in the art will appreciate that the three-dimensional data that may be acquired by the method and apparatus of the invention includes, but is not limited to, data related to geometry, distance, texture, velocity, temperature, and scale. In addition, those skilled in the art will appreciate that any of the above-described aspects or embodiments of the invention may be used in connection with any of the applications of three-dimensional imaging noted above, including generation of a three-dimensional representation of a subject, detection or analysis of subject movements, detection of flaws in the subject, subject identification or recognition, and targeting or range finding.

To this end, the invention is not to be limited to capture of the grids, patterns, or signatures by a particular camera or detector arrangement or type, to particular numbers, arrangements, or types of projection equipment, or to grids having a particular frequency or range of frequencies. Either the projectors (if utilized) or the detectors may be fixed or movable, each grid, pattern, or signature may be captured by one or more detectors, and each detector may be arranged to capture one or more grids, patterns, or signatures. Furthermore, where projected grids are used, the “grids” may be in the form of patterns other than grids made up of mutually perpendicular sets of lines, or may be collapsed into one-dimensional lines captured by separate detectors and combined following detection, and the grids may be projected in combination with other types of indicia such as hash marks used for targeting or range finding.

Range finding may be achieved either by aligning images of multiple grids, patterns, or signatures, whether the result of grid projection, emission by the subject, or patternless illumination, in the manner of a conventional photographic camera viewfinder, or by isolating a point on a projected grid or discriminated pattern or signature and scanning the subject with a ladar radar (ladar) device.

### BRIEF DESCRIPTION OF THE DRAWINGS

FIG. 1 is a side view of a subject illuminated by an infrared grid projection system constructed in accordance with the principles described in copending U.S. patent application Ser. Nos. 09/987,336 and 09/969,583.

FIG. 2 is a side view illustrating the use of multiple projection systems to complete a 360° view of the subject.

FIG. 3 is a front view of the subject illustrated in FIG. 1.

FIG. 4 is a perspective view showing grid distortion along contours of the subject illustrated in FIG. 1.

FIG. 5 illustrates a captured image taken in the presence of visible light and containing two infrared grids projected from different angles, together with the results of wavelength separation of the composite image into separate images of the two infrared grids and a visible image of the subject.

FIGS. 6 and 7 illustrate filtering apparatus utilized by the present invention.

FIG. 8 is a schematic illustration showing use of the invention for range finding.

FIG. 9 is a schematic illustration showing a complete imaging system utilizing a stereoscopic arrangement corresponding to the arrangement shown in FIG. 5.

FIGS. 10-13 are schematic diagrams of various airplane and airport security applications corresponding to those described in copending U.S. patent application Ser. Nos. 09/987,336 and 09/969,583.

FIG. 14 is a schematic diagram of a tracking or targeting system that utilizes the principles of the invention.

FIGS. 15 and 16 is are schematic diagrams of tracking systems corresponding to that of FIG. 14, but in which the projected grids are replaced by reflections resulting from patternless illumination, or by radiation signatures of the subject.

FIGS. 17A-17C are schematic diagrams illustrating use of fiber optics in connection with the preferred embodiments of the invention.

FIGS. 18A-18E are schematic diagrams illustrating variations of the receiver illustrated in FIGS. 6 and 7.

### DETAILED DESCRIPTION OF THE PREFERRED EMBODIMENTS

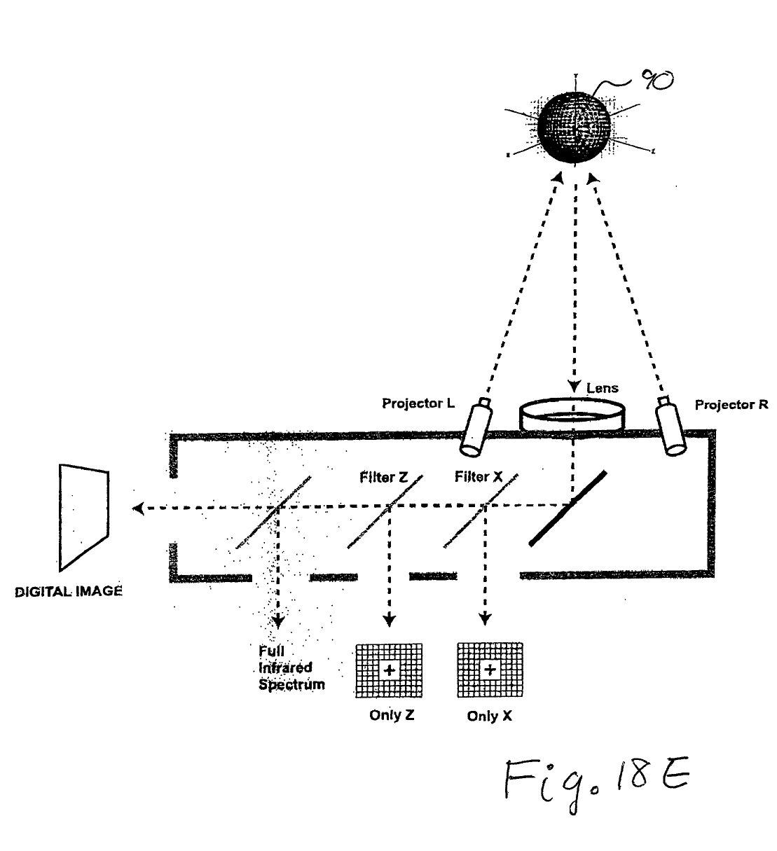

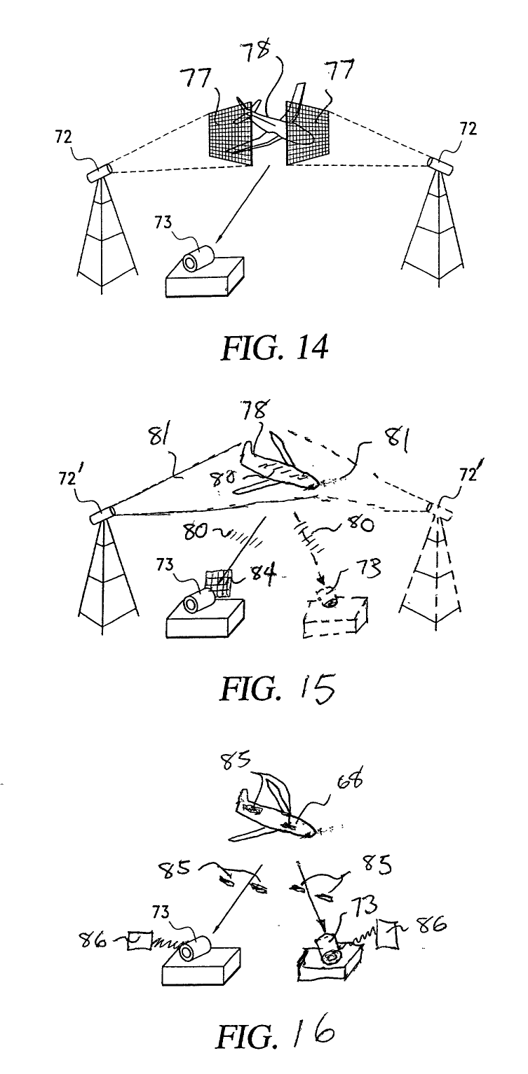

The present invention extends the principles described in the copending applications to encompass patterns resulting from illumination of a subject using patternless illumination, radiation signatures emitted by the subject itself, and combinations of projected grids, patternless illumination, and radiation signatures. Initially, the invention will be described in connection with the projected grids illustrated in FIGS. 1-14, but it should be kept in mind that any of the specific arrangements illustrated in FIGS. 1-14 may be modified such that one or more of the sources projects patternless light rather than a grid, and that the illumination sources may be entirely omitted where detectable and identifiable radiation signatures are emitted by the subject even without external illumination. Specific examples of systems that do not utilize projected grids, in accordance with the principles of the present invention, are illustrated in FIGS. 15, 16, and 18. FIG. 17 illustrates the use of fiber optics to guide an image to a receiver in any of the illustrated embodiments

FIG. 1 illustrates an embodiment of the invention in which the subject 1 is illuminated by a single infrared grid 2 projected from the front of the subject by a projector 3, as described in copending U.S. patent application Ser. Nos. 09/987,336 and 09/969,583. Although illustrated as involving a projected grid or grids, the subject 1 may also be illuminated by a substantially uniform light source 4, by multiple light sources, or by ambient light.

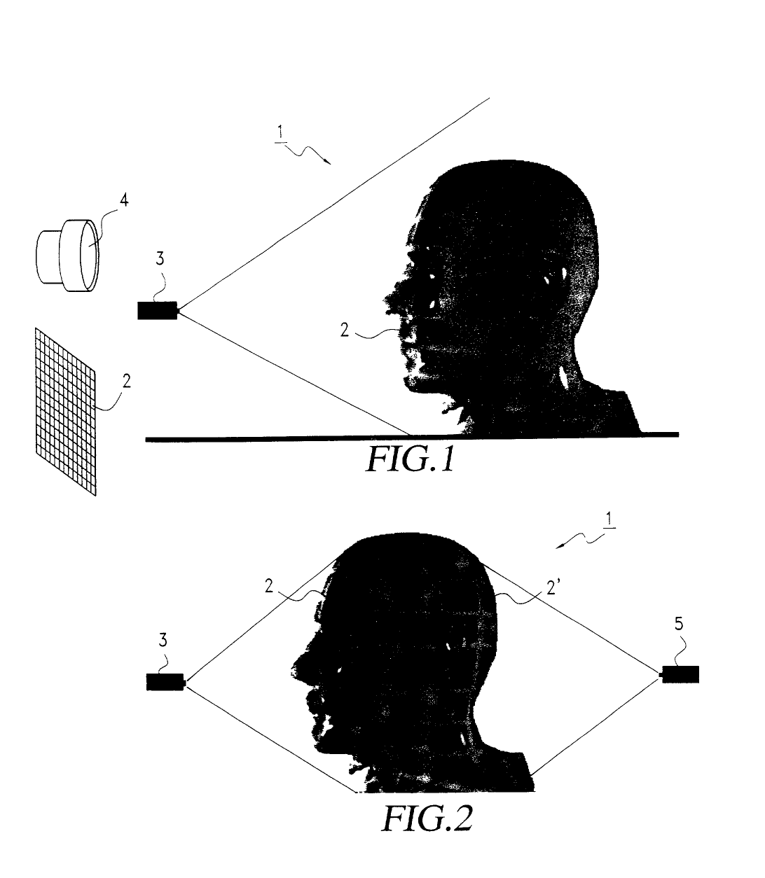

In a variation of the embodiment of FIG. 1, multiple grids 2 and 2′ may be projected onto the subject in order to enable capture of contours for the entire 360° of the subject by using an additional camera 5 (or, equivalently, by moving projector 3 around the subject), as illustrated in FIG. 2.

Each grid shown in FIGS. 1 and 2 is preferably an infrared grid having a wavelength of sufficient intensity to enable an image of the grid to be captured despite background infrared radiation that might be emitted by the subject, and is made up of mutually perpendicular horizontal and vertical lines. Suitable infrared light sources are well-known, as are cameras and film capable of capturing infrared light. The projectors 3 and 5 may be simple lamp and mask arrangements in which the lamp is arranged to illuminate the subject through a mask having openings in the shape of a grid, or an arrangement in which the lamp is reflected by a grid-shaped reflector, although the invention is not to be limited to such lamp and mask or reflector arrangements.

Light source 4 may be a visible, infrared, or ultraviolet light source for enabling the camera to capture features of the subject other than the contours reflected in the captured grid. According to the principles of the invention, the exact wavelength or wavelengths of light source 4 may be freely varied to meet requirements of the application in which the invention is used, except that the wavelength or wavelengths emitted by the light source 4 must be different than those emitted by projector 3. As explained below, use of different wavelengths to illuminate the subject as a whole than are used for the grid makes it possible to more easily separate the image of the grid from that of the subject.

It may, in some circumstances, be useful simply to capture an image of the infrared grid without illumination of the entire subject, in which case lamp 4 may be omitted. On the other hand, a significant advantage of the invention is that it permits a visible, ultraviolet, or infrared light image of the subject to be captured with the grid superposed so that aspects of the subject such as coloring, and also details of physical features smaller than the smallest grid unit, can be captured and located with reference to the grid.

Although infrared light is preferred for many applications, the principles of the invention are not limited to infrared grids, or to grids having a specific frequency. In some applications, it may be desirable to use multi-spectrum waves, enabling the penetration of current guidance defense techniques and/or to increase effectiveness over the widest variety of environmental conditions. The only requirements are that the light used to illuminate the subject, and the light projected to form each grid, be of different frequencies or ranges of frequencies so as to enable separation by beam splitters having appropriate bandwidths.

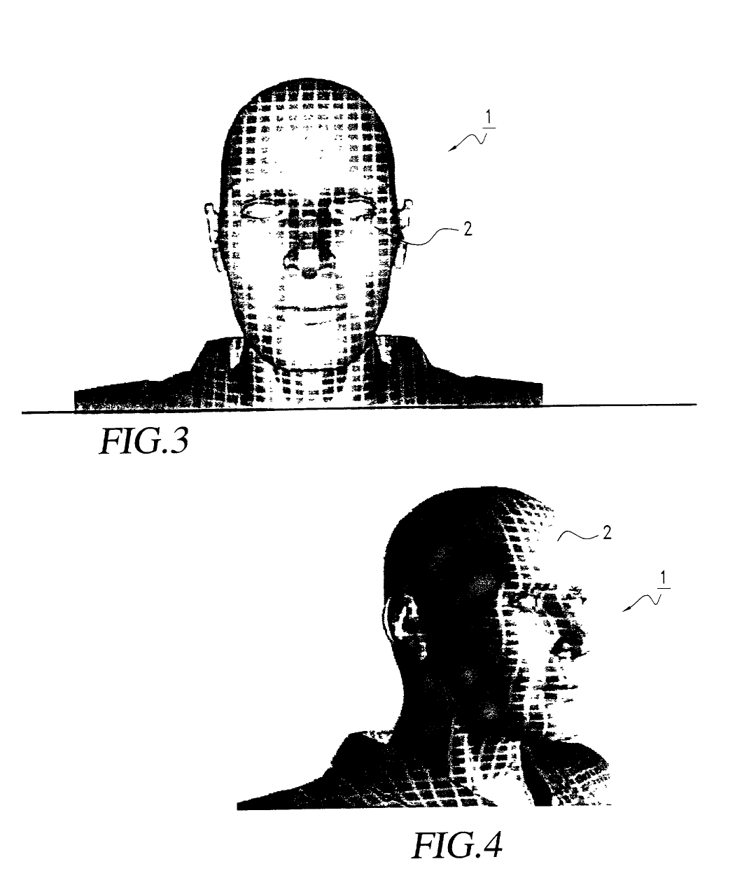

As illustrated in FIG. 3, the use of a single grid 2, or corresponding single grids 2 and 3 projected onto the front and back of the subject, does not by itself permit contours of the subject to be determined. Instead, contours of the subject are only revealed by capturing the image at an angle relative to the side of the subject whose contours are to be captured or analyzed, as illustrated in FIG. 4. By using two cameras on each side of the projector, a stereoscopic view can be captured using a single grid.

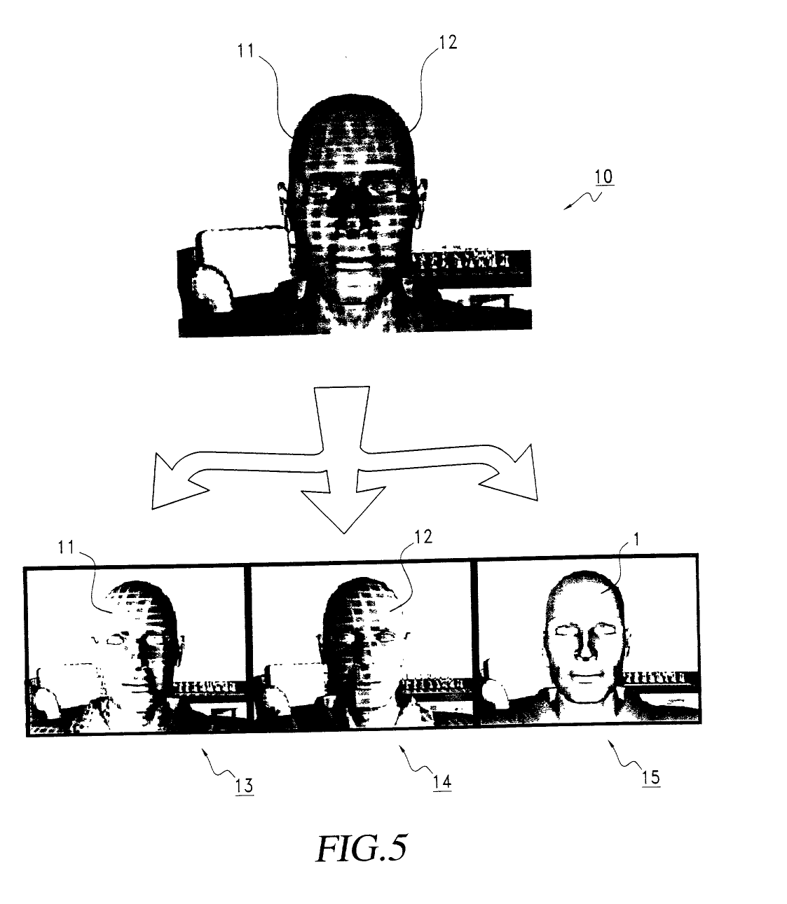

In order to avoid the need to capture two images of the subject, however, it is also possible to create a stereoscopic effect by orienting the projectors at angles relative to the subject, and positioning the camera midway between the projectors, as illustrated in FIG. 5. Image 10 in FIG. 5 is a front view of the subject onto which has been projected two infrared grids 11 and 12 using two projectors (not shown) of the type illustrated in FIG. 2, oriented at equal angles on each side of the camera or image capture apparatus. According to the principles of the invention, the composite image 10 consists of, and may be separated into, three constituent images: (i) an image 13 of the first grid 11, (ii) an image 14 of the second grid 12, (iii) a image 15 of the subject without the grids. Although images 13 and 14 show the subject and background, the subject and background can be made to disappear by selecting appropriate grid wavelengths and bandwidths of the filters or beam splitters used to separate the images, leaving only images of the respective grids. Of course, by adding one or more cameras and projectors to the arrangement illustrated in FIG. 5, or by moving the cameras and projectors of FIG. 5 around the subject, it is possible to capture a 360° view of the subject.

Separation of image 15 from images 13 and 14 is accomplished, as described above, by using different wavelengths for image 15 and the grids in images 13 and 14. In addition, the left and right grids in images 13 and 14 are preferably also projected using light sources of different frequency.

Image processing techniques for generating a three-dimensional image of a subject based on contours are well-known and need not be described in detail herein. However, image processing is uniquely facilitated in the system and method of the present invention by including a filtering device 20 that optically, rather than electronically, separates the one or more infrared grids from the visible light image. This device may be used to separate light reflected directly from the subject, in lieu of a camera, or may be used to process a recorded image or slide, or an image of the subject displayed on a CRT, LCD, or the like.

The filter device 20 includes a pair of beam splitters 21 and 22, one of which is arranged to separate the infrared light of the grid from the light used to illuminate the subject, which may be visible light, and the other of which is arranged to separate infrared light of different frequencies. The first beam splitter transmits the image of the subject to a detector A while reflecting the infrared light images of the two grids. The second beam splitter separates the infrared light images of the two grids into separate images of the respective grids by transmitting one frequency of infrared light to a detector B and the other frequency of infrared light to a detector C for separate, simplified processing.

In the variation illustrated in FIG. 7, device 25 includes beam splitters 26 and 27 arranged to separate light of different frequencies in the same manner as beam splitters 21 and 22, except that the image of the subject is reflected rather than transmitted to detector A, and the image of the first grid is reflected rather than transmitted to detector B.

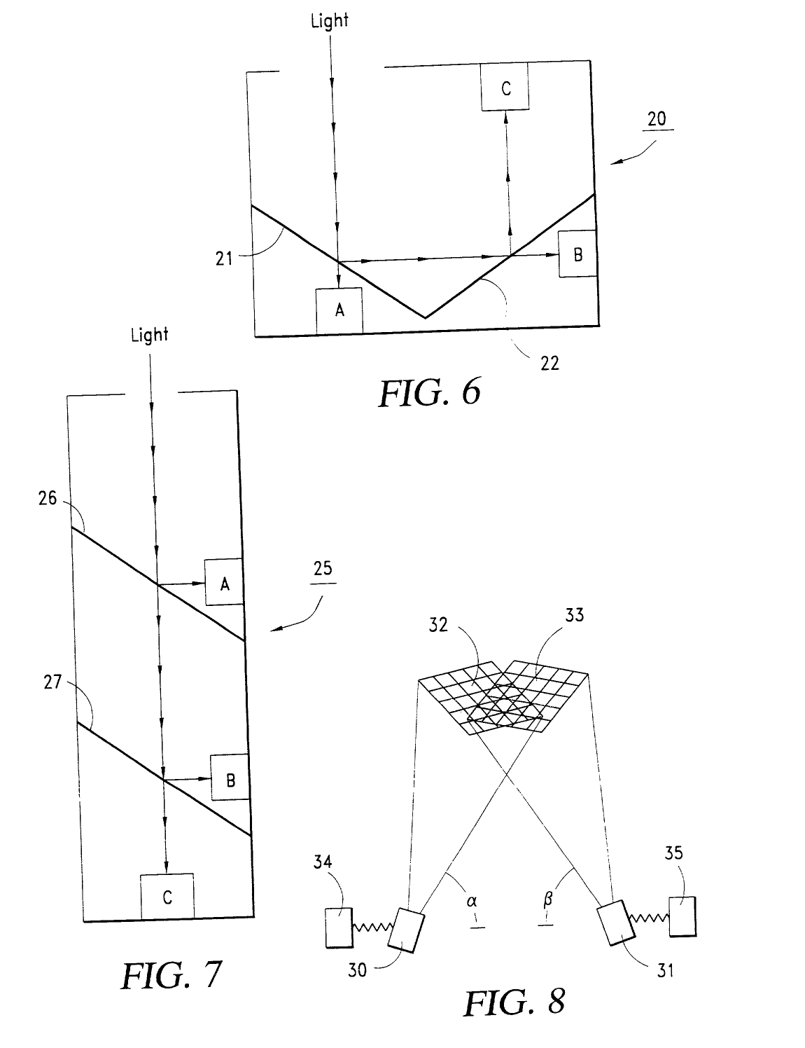

It will be appreciated by those skilled in the art that suitable beam splitters are well-known and readily available or manufacturable. In addition, the beam splitters may be replaced by other filter arrangements, such as an arrangement in which the composite image is filtered by parallel filters for the three frequencies, rather than series arrangements illustrated in FIGS. 6 and 7, i.e., the composite image duplicated twice and directed to separate filters for transmission of the respective images. Alternatively, the filter arrangements may be replaced by image capture devices or media sensitive to the wavelength or frequency of one of the respective grids, but not to the wavelength or frequency of the other grid or of the background illumination.

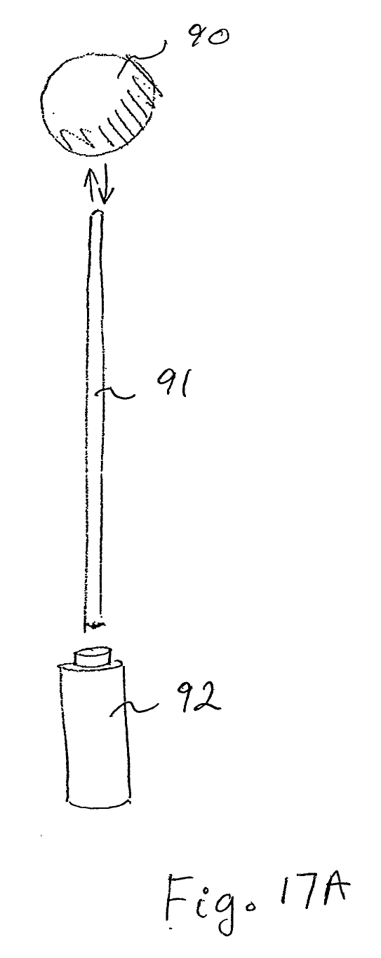

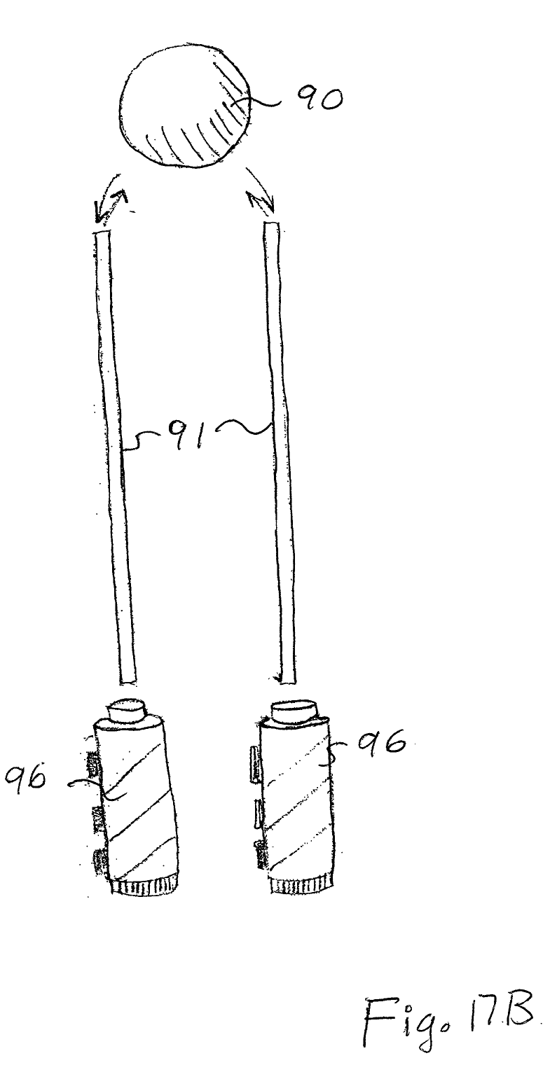

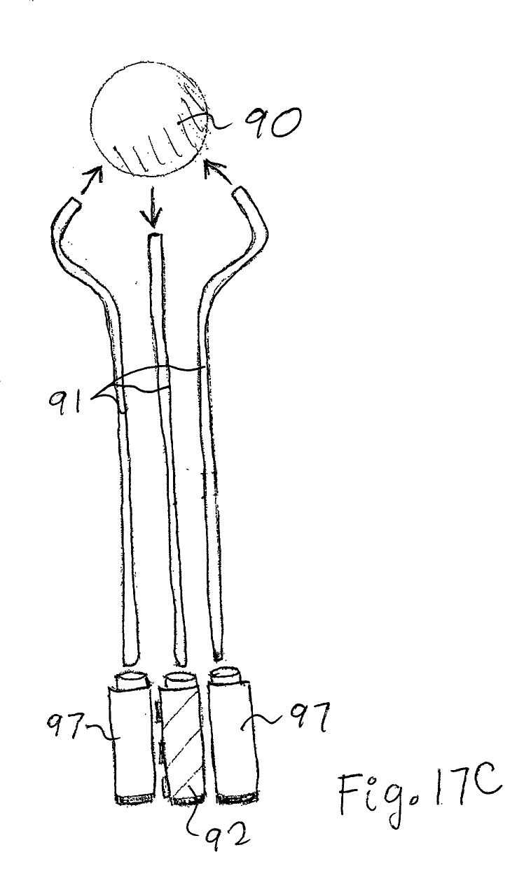

FIGS. 18A-18E show further variations of the receiver of FIGS. 6 and 7. In the arrangement illustrated in FIG. 18A, data is captured by digital image capture devices and supplied to a computer. The images X and Y are not necessarily projected grids, but rather may be the result of illumination by uniform or patternless light sources, scanning, or emissions originating from the subject itself. Otherwise, the operation of the receiver is similar to that illustrated in FIG. 7, with the image data being separated into distinct data groups optically (on-the-fly), thereby enabling available computing resources to be more fully dedicated to analysis and conversion of data.

In the receiver 92 illustrated in FIG. 18B, a third beam splitter 93 and image capture device are added to the receiver, to not only permit separation of projected grids or other reflected patterns from a composite image of the subject 90, but also to separate an image in the full infrared spectrum from the composite visible/infrared image. The full infrared image provides a thermal profile of the subject and, in combination with geometric data and the composite image, can be used deduce or reverse engineer internal components of the subject, which might, for example, be a missile or aircraft.

In the receiver 92′ illustrated in FIG. 18C, masks or filters 94 are positioned in front of the image capture device to provide a reference for, or to further facilitate, analysis of the extract images of the reflected patterns and full infrared image. Similarly, in the receiver 82″ illustrated in FIG. 18D, the masks or filters are integrated into or otherwise associated with the beam splitters 95.

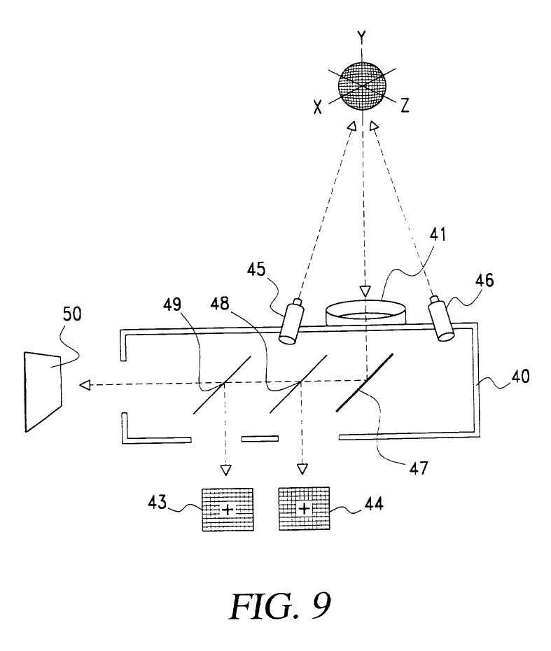

Finally, the receiver of FIG. 18E is a digital camera corresponding to the receiver of FIG. 9, but with an additional beam splitter arranged to separate a full infrared image of the subject 90 from the composite image of the subject.

In the embodiment illustrated in FIG. 8, two projectors 30 and 31 are aimed at a subject (not shown), with the objective of creating a set of stereoscopic profiles corresponding to those illustrated in FIG. 5. However, the arrangement of this embodiment has the added feature that the azimuth of the projectors may be adjusted by mechanisms 34 and 35 so that the grids can be positioned on subjects at various distances from the projector. In that case, the azimuth angles α and β of the detectors when the grids overlap, i.e., upon alignment of corresponding hash marks, will give the relative angles and distance from the projectors to the subject. Those skilled in the art will appreciate that rather than adjusting the azimuth of at least one of the receivers, it is also possible to track an object by monitoring grids projected at a fixed angle, the distance to the subject being known when landmarks on the reflected grids coincide.

In the embodiment illustrated in FIG. 9, the projectors and receiver are combined to form a digital imaging camera 40 having a lens 41 for focusing the image of the subject 42 and corresponding reflected grids 43,44 projected by respective left and right projectors 45,46. The grids have hash marks to enable range finding as described above in connection with FIG. 8, and are reflected by mirror 47 to a pair of beam splitters 48,49 that separate the grids and output an image 50 to a viewer or imaging device such as a CCD.

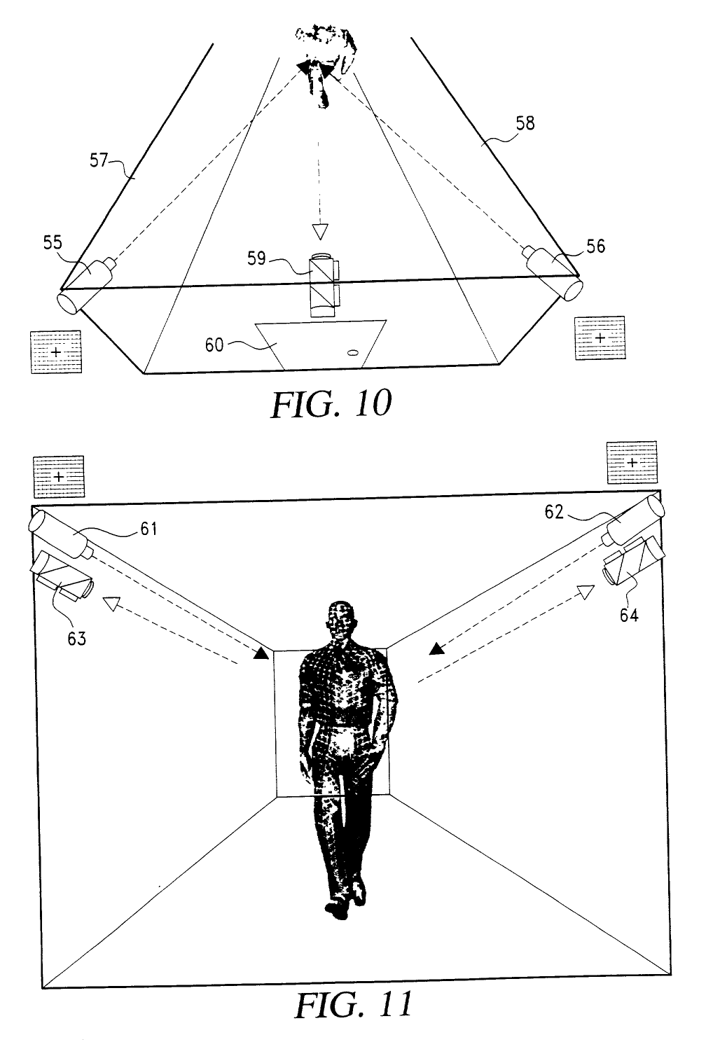

Although the invention is suitable for applications too numerous to specify, one application for which there is an especially urgent need is airport security. In the arrangement illustrated in FIG. 10, projectors 55 and 56 are hidden in the walls 57,58 of an airport corridor and a receiver 59 corresponding to the one illustrated in FIG. 9 is hidden above a doorway or entrance 60 in order to capture stereoscopic images or image data for analysis by pattern matching, curve fitting, or other well-known data processing techniques. Alternatively, as illustrated in FIG. 11, projectors 61,62 may be associated with separate receivers 63,64, each including a single beam splitter or other image capture device sensitive to the wavelength or frequency of a corresponding grid.

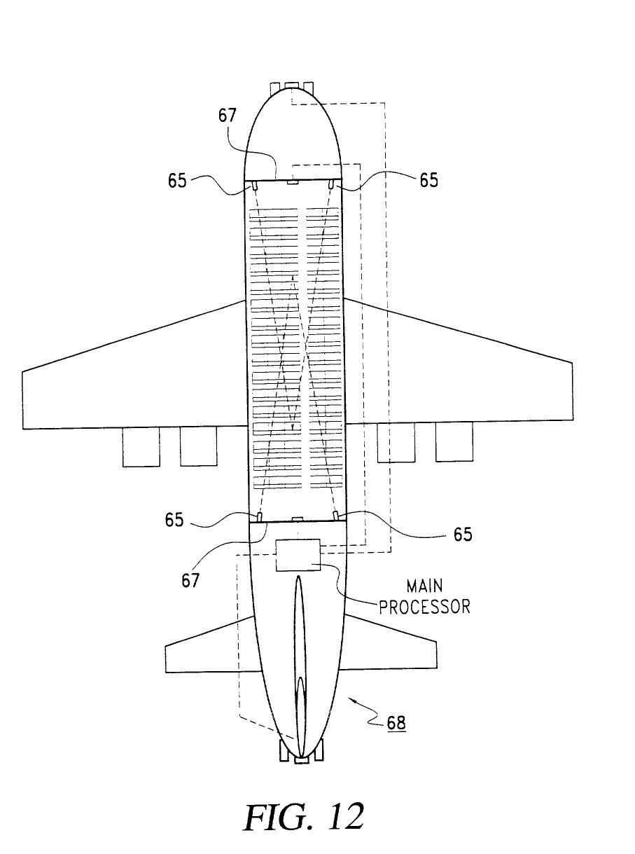

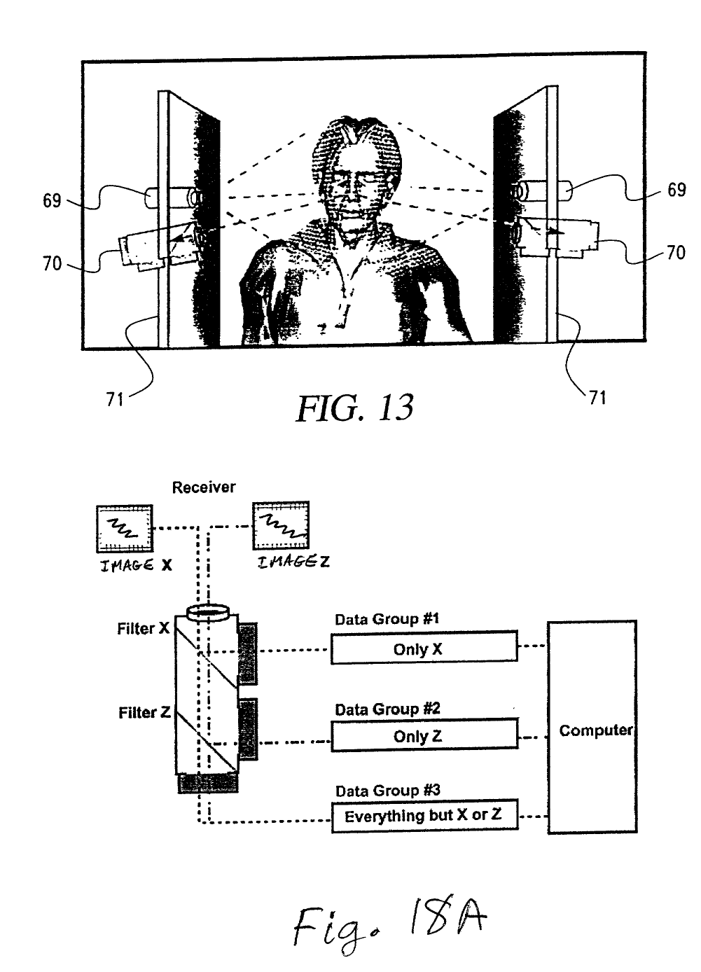

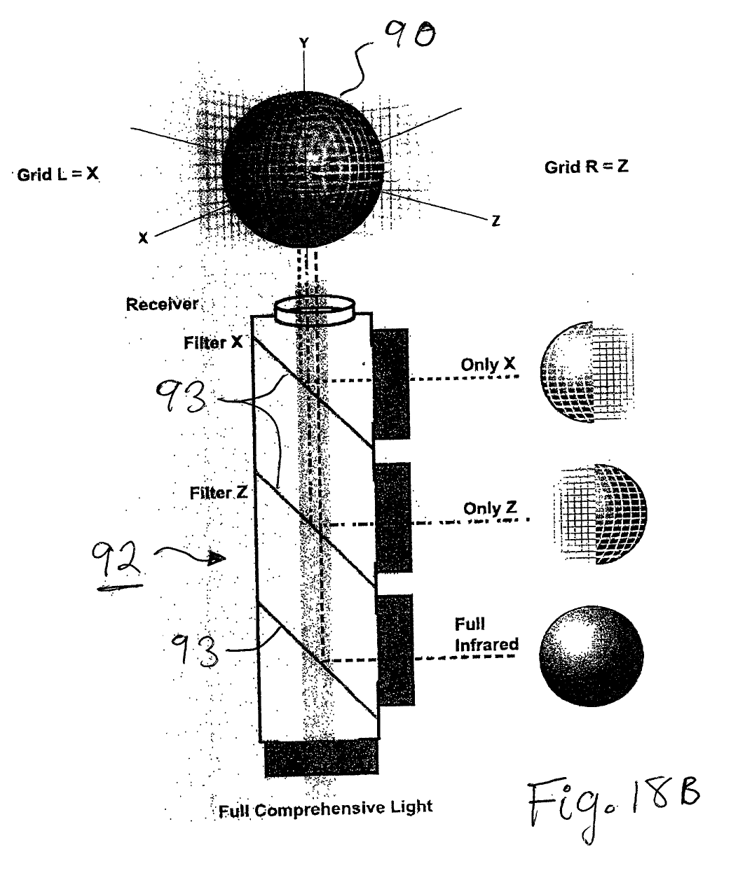

In the arrangement illustrated in FIG. 12, projectors 65 and receivers 66 corresponding to those illustrated in FIG. 10 are arranged in the front and rear bulkheads 67 of the cabin of a passenger airplane 68, while in the arrangement illustrated in FIG. 13, projectors 69 and receivers 70 corresponding to those illustrated in FIG. 11 are positioned in the walls 71 of a walk-through metal detector.

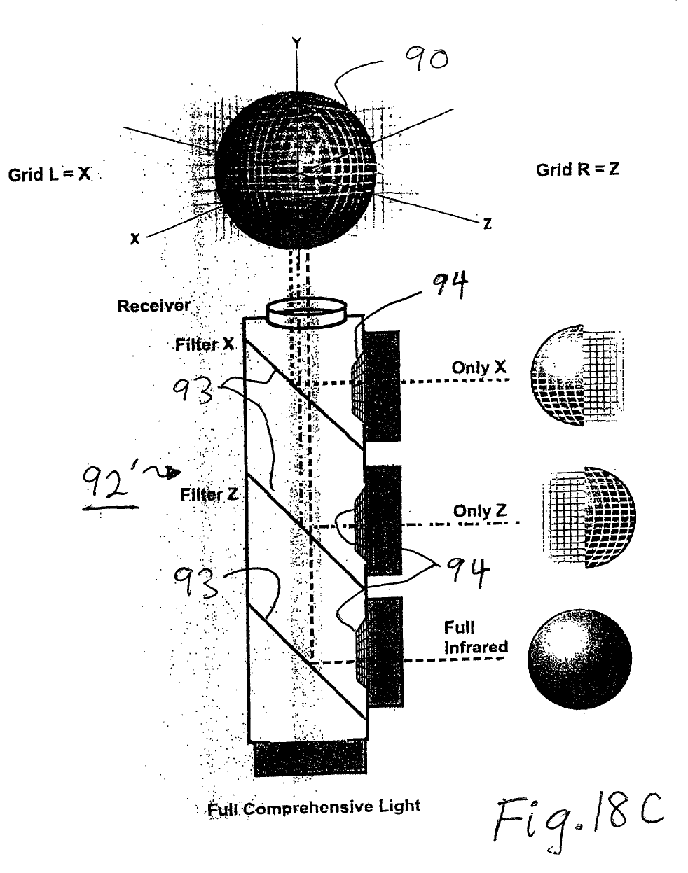

FIG. 14 shows a tracking or targeting system utilizing tower mounted grid projectors 72 and a central receiver 73 corresponding to the arrangement of FIGS. 10 and 12, while FIG. 15 shows a satellite mounted system corresponding to the arrangement shown in FIGS. 11 and 13, with separate receivers 74 for each projector 75. The satellite-based system of FIG. 15 could be used as part of an anti-ballistic missile defense system, to track cloud formations, for mapping, or for a variety of other scientific and military purposes.

FIG. 15 shows a tracking or targeting system in which grid projectors 72 of FIG. 14 are replaced by one or more patternless light sources 72′ arranged to illuminate the subject with light 81 having specific frequencies, or with light that results in reflections 80 having specific frequencies, the reflections being capable of discrimination by one or more detectors 73 corresponding to the detector illustrated in FIG. 14. Those skilled in the art will appreciate that the positions of sources 72′ and detectors 73 will depend on the specific application in which the detectors and sources are used, and that the illustrated arrangement is not to be taken as limiting. Furthermore, those skilled in the art will appreciate that any or all of the detector(s) 73 may further include a reference mask, pattern, or matched filter 84.

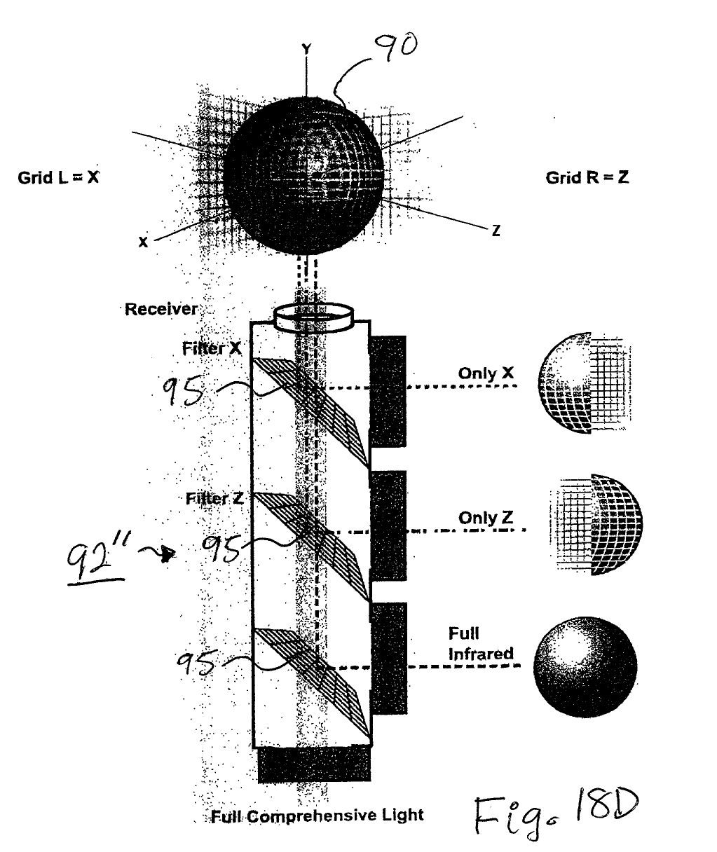

FIG. 16 shows a further extension of the principles of the invention, in which external illumination sources 72′ are omitted and a radiation signature of the subject is instead passively detected by at least two receivers 73. FIG. 16 also shows the feature whereby at least one of the receivers 73 is arranged to be moved by a controller 86 in order to permit tracking or range finding according to the principles described above.

Finally, FIGS. 17A-17C illustrate the principle that one or more optical fibers 91 could be used to transmit images of the subject 90 to a receiver 92,96 and/or to project grids or other patterns from sources 96,97 onto the subject 90. In the embodiment of FIG. 17A, the grid or pattern is projected by conventional means, while in the embodiment of FIG. 17B, both projection and image capture are carried out through the same fibers and receiver/projector combinations 96 (for example by alternating projection and image capture) and in the embodiment of FIG. 17C, separate projectors 97 and receiver 92 with corresponding fibers 91 are provided. Those skilled in the art will appreciate that arrangements of optical fibers could be used with any of the embodiments illustrated in FIGS. 1-16, or in any of the embodiments illustrated in parent application Ser. Nos. 09/987,336 and 09/969,583.

Having thus described various preferred embodiments of the invention in sufficient detail to enable those skilled in the art to make and use the invention, it will nevertheless be appreciated that numerous variations and modifications of the illustrated embodiment may be made without departing from the spirit of the invention. For example, the receivers of the invention may be used in connection with a night vision helmet, with one side providing an infrared image of the subject and the other providing a composite image. It is therefore intended that the invention not be limited by the above description or accompanying drawings, but that it be defined solely in accordance with the appended claims.

I claim:

1. A system for capturing images and data related to a subject in a format that facilitates interpretation of the images and data by a human viewer or processing by a computer or other electronic processing device, wherein the subject emits or reflects a specific radiation pattern or signature within a predetermined range of frequencies, comprising:
at least one frequency discriminator including at least one beam splitter arranged to optically separate the received image of the emitted or reflected pattern or signature from a composite image of the subject.

2. A system as claimed in claim 1, further comprising at least one patternless illumination source, wherein said specific radiation pattern or signature results from reflection of radiation emitted by said illumination source at frequencies.

3. A system as claimed in claim 1, wherein said specific radiation pattern or signature is a radiation signature emitted by the subject, and wherein said system comprises at least two said discriminators.

4. A system for capturing images and data related to a subject in a format that facilitates interpretation of the images and data by a human viewer or processing by a computer or other electronic processing device, comprising:
a first illumination source arranged to project a light having a first range of frequencies onto said subject;
a receiver arranged to optically separate an image of said subject formed by reflected light of said first range of frequencies from a composite image of said subject.

5. A system as claimed in claim 4, wherein said light having a first range of frequencies is infrared light and said composite image includes reflections in said first range of frequencies and visible light reflections.

6. A system as claimed in claim 4, further comprising a second light source, said second light source being arranged to project light onto said subject from a different angle than said first light source.

7. A system as claimed in claim 6, wherein said second light source has a same frequency range as said first light source.

8. A system as claimed in claim 6, wherein said second light source has a different frequency range than said first light source.

9. A system as claimed in claim 4, wherein said receiver includes a pair of beam splitters.

10. A system as claimed in claim 9, wherein said receiver includes a third beam splitter for separating a full infrared image from a visible/slash composite image of the subject.

11. A system as claimed in claim 4, further comprising a range-finding device arranged to determine a distance from said receiver or light source to said subject.

12. A system as claimed in claim 4, wherein said subject and receiver are optically coupled by means of optical fibers.

13. A system as claimed in claim 12, wherein said illumination source and said subject are optically coupled by means of optical fibers.

14. A system as claimed in claim 4, wherein said illumination source and said subject are optically coupled by means of optical fibers.

15. A method for capturing images and data related to a subject in a format that facilitates interpretation of the images and data by a human viewer or processing by a computer or other electronic processing device, comprising:
projecting light from a first illumination source having a first range of frequencies onto said subject;
optically separating an image of said subject formed by reflected light of said first range of frequencies from a composite image of said subject.

16. A method as claimed in claim 15, further comprising the step of projecting light from a second image source onto said subject from an angle that is different than an angle at which said light from said first image source is projected.

17. A method as claimed in claim 15, wherein said light having a first range of frequencies is infrared light and said composite image includes reflections in said first range of frequencies and visible light reflections.

18. A method as claimed in claim 15, further comprising a light source, said second light source being arranged to project light onto said subject from a different angle than said first light source.

19. A method as claimed in claim 18, wherein said second light source has a same frequency range as said first light source.

20. A method as claimed in claim 6, wherein said second light source has a different frequency range than said first light source.
